(19) United States
(12) Patent Application Publication
(10) Pub. No.: US 2018/0067854 A1
(43) Pub. Date: Mar. 8, 2018

(54) AGGRESSIVE WRITE-BACK CACHE CLEANING POLICY OPTIMIZED FOR NON-VOLATILE MEMORY

(71) Applicant: Intel Corporation, Santa Clara, CA (US)

(72) Inventors: Maciej Kaminski, Gdansk (PL); Mariusz Barczak, Gdansk (PL)

(73) Assignee: Intel Corporation, Santa Clara, CA (US)

(21) Appl. No.: 15/258,521

(22) Filed: Sep. 7, 2016

(51) Int. Cl. G06F 12/0804; G06F 12/0842; G06F 12/0868; G06F 12/0873

(52) U.S. Cl. CPC G06F 12/0804; G06F 12/0842; G06F 12/0868; G06F 12/0873; G06F 2212/313; G06F 2212/1032; G06F 2212/222; G06F 2212/305; G06F 2212/1016

(57) ABSTRACT

Methods and apparatus related to an aggressive write-back cache cleaning policy optimized for Non-Volatile Memory (NVM) are described. In one embodiment, dirty cache lines are sorted by their LBA (Logic Block Address) on backend storage and an attempt is made to first flush (or remove) the largest sequential portions (including one or more cache lines). Other embodiments are also disclosed and claimed.

### FIELD

The present disclosure generally relates to the field of electronics. More particularly, some embodiments generally relate to an aggressive write-back cache cleaning policy optimized for Non-Volatile Memory (NVM).

### BACKGROUND

In computing, a “cache” generally refers to a hardware or software component that stores data for faster future accesses. A “cache hit” occurs when the requested data is found in the cache, while a “cache miss” occurs when the requested data is absent from the cache.

Various cache policies may be used, e.g., to tradeoff between speed and data correctness. One such policy that results in faster speeds but may pose data correctness issues is a write-back cache policy. Write-back (sometimes also called write-behind) refers to a policy where the initial writing is done only to the cache. The write to the backing store is postponed until the cache blocks containing the data are about to be modified or replaced by new content. Hence, the write-back cache policy can be more complex and time-consuming to implement since future modifications or replacements need to be tracked to maintain data correctness and may sometimes result in two memory operations (one to write the replaced/modified cached data to the back store and another operation to retrieve the requested data).

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 3, 4, and 5 illustrate block diagrams of embodiments of computing systems, which may be utilized to implement various embodiments discussed herein.

FIG. 2A illustrates a block diagram of two-level system main memory, according to an embodiment.

FIG. 2B illustrates a flow diagram of a method to provide an aggressive write-back cache cleaning policy for an NVM, according to an embodiment.

FIG. 2C illustrates a sample graph of switching between different cache cleaning policies, according to an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

Due to costs and/or space limitations, cache sizes are generally smaller than other types of memory such as backing stores. Hence, maintaining only valid data in a cache can be helpful and, to do so, cache cleaning policies may be used. As discussed herein, a cache cleaning policy generally refers to a policy that ensures that dirty data in a cache is written to primary (or backing) storage before it is removed from the cache. Moreover, “dirty” data generally refers to unsynchronized (or “unsynced”) data which is stored in a cache media and not yet copied back (or written back) to a backing store/storage (such as one or more of an SSD (Solid State Drive), HDD (Hard Disk Drive), Hybrid Drive, etc.). However, various issues remain with some current cache cleaning policies. For example, some solutions may focus on cleaning Least Recently Used (LRU) blocks first, which can lead to one seek (or random access) operation per each dirty cache line cleaned for an average case. Thus, CAS (or Cache Acceleration Software), which may be used in some implementations, may be unable to clean dirty data in the background efficiently. As discussed herein, operations directed at a cache may be directed at a portion of the cache called a “cache line” which may be about 4 kiloBytes (kB), 64 kB, 512 kB, 1024 kB, etc. in various embodiments.

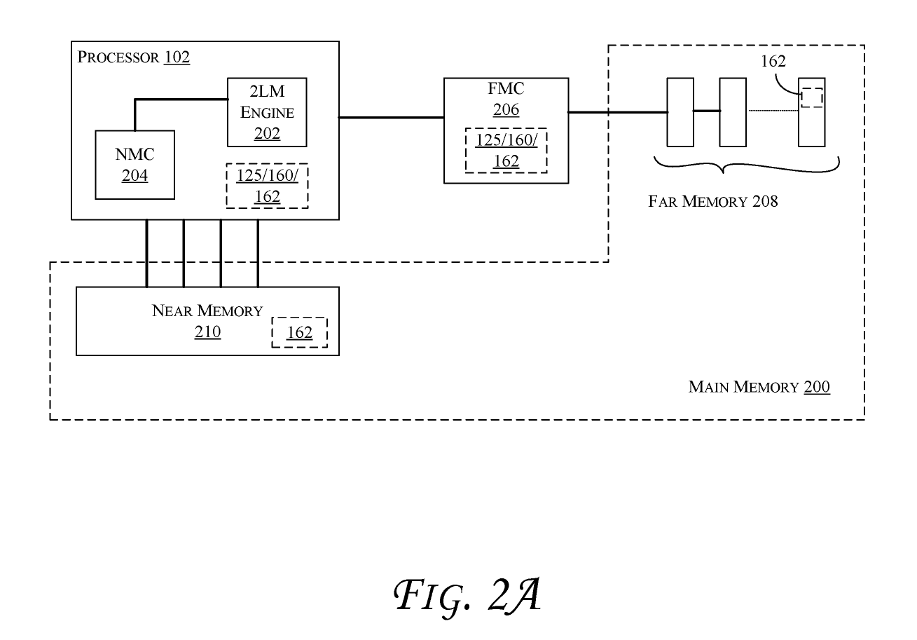

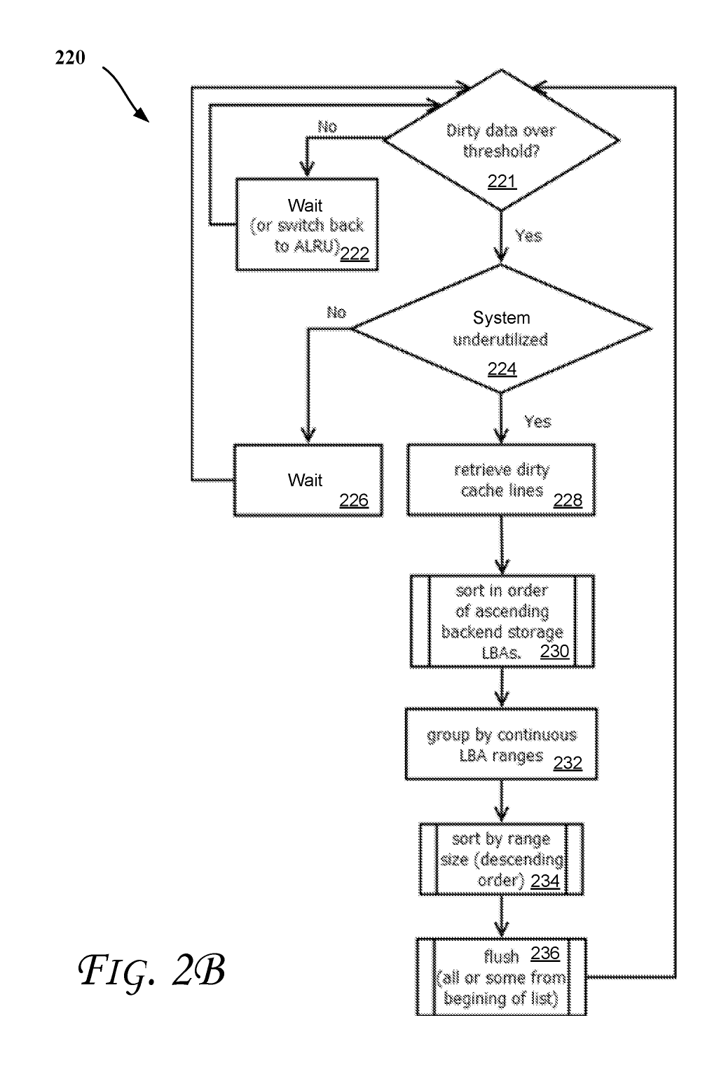

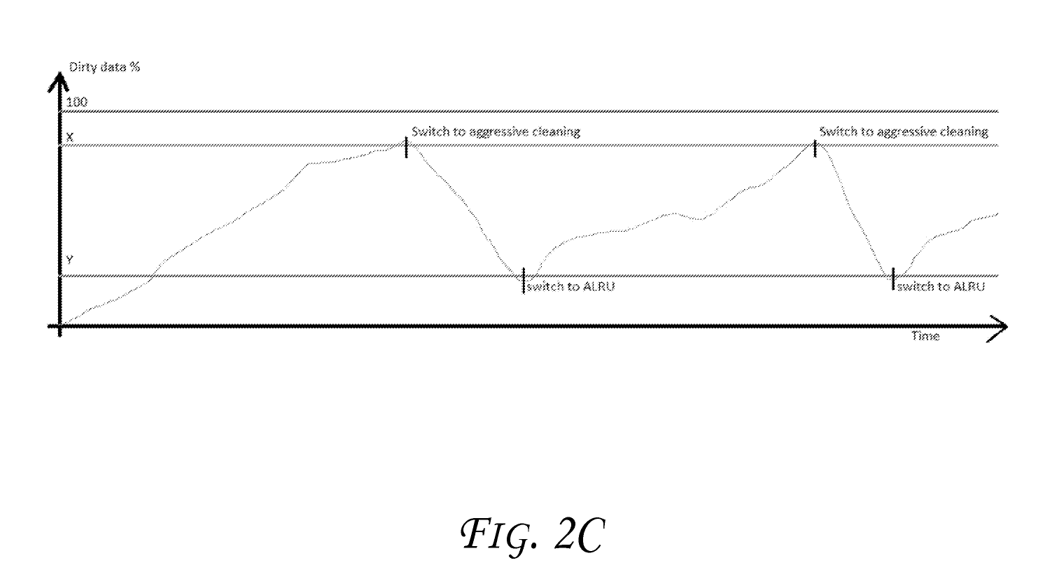

Some embodiments relate to an aggressive write-back cache cleaning policy optimized for Non-Volatile Memory (NVM). In an embodiment, dirty cache lines are sorted by their LBA (Logic Block Address) on backend storage and an attempt is made to first flush (or remove) the largest sequential portions (including one or more cache lines). As discussed herein, a “backing” or “backend” storage/store generally refers to any NVM device or NVM medium (such as those discussed herein) that is capable of storing data on a non-volatile or permanent basis. As discussed herein, NVM medium may include one or more of HDD, SSD, Hybrid Drive, etc. For example, the backing storage system may include near and/or far memory such as those discussed with reference to FIG. 2A. Hence, in a write-back cache configuration, data may be first stored in the cache until there is an indication that that data is going to be modified/replaced, at which point the data is stored or committed to the backing store.

In one embodiment, the aggressive write-back cache cleaning policy is aimed at reducing the amount of dirty data at the fastest rate possible by optimizing it for sequential Hard Disk Drive (HDD) storage (or more generally NVM) writing operations. When compared to some other solution (e.g., an ALRU or Approximately Least Recently Used cleaning policy), the aggressive write-back cache cleaning policy may lead to significantly lower number of seek operations, as well as much lower time to reduce the volume of dirty data. This may translate to up to 80× transfer rates for cache cleaning (leading to improved IO (Input Output) performance) and a reduced vulnerability window for data loss.

Additionally, usage of such an aggressive cleaning policy may decrease dirty data fractions; thus, allowing for more efficient eviction operations. Moreover, with less dirty data at any given period of time, it is possible to reduce the data loss vulnerability window (for example, where a cache device is configured as a mirror, transitioning to write-through policy when mirror is degraded will be quicker with less dirty data). A “write-through” policy generally refers to a policy to service a write operation by synchronously/simultaneously writing to both the cache and to the backing store. Also, a “mirror” generally refers to a Redundant Array of Independent Disks (RAID), where a RAID-1 volume provides a data protection scheme by mirroring/storing the same data on two separate storage devices, e.g., mirrored SSDs refers to a pair of SSDs containing the same data. This provides data protection in case one of the SSDs malfunctions or breaks.

Furthermore, one or more embodiments discussed herein may be applied to any type of memory including Volatile Memory (VM) and/or Non-Volatile Memory (NVM). Also, embodiments are not limited to a single type of NVM and non-volatile memory of any type or combinations of different NVM types (e.g., including NAND and/or NOR type of memory cells) or other formats usable for memory) may be used. The memory media (whether used in DIMM (Dual Inline Memory Module) format, SSD (Solid State Drive), or otherwise) can be any type of memory media including, for example, one or more of: nanowire memory, Ferro-electric Transistor Random Access Memory (FeTRAM), Magnetoresistive Random Access Memory (MRAM), multi-threshold level NAND flash memory, NOR flash memory, Spin Torque Transfer Random Access Memory (STTRAM), Resistive Random Access Memory, byte addressable 3-Dimensional Cross Point Memory, single or multi-level PCM (Phase Change Memory), memory devices that use chalcogenide phase change material (e.g., chalcogenide glass) or “write in place” non-volatile memory. Also, any type of Random Access Memory (RAM) such as Dynamic RAM (DRAM), backed by a power reserve (such as a battery or capacitance) to retain the data, may provide an NV memory solution. Volatile memory can include Synchronous DRAM (SDRAM). Hence, even volatile memory capable of retaining data during power failure or power disruption(s) may be used for memory in various embodiments.

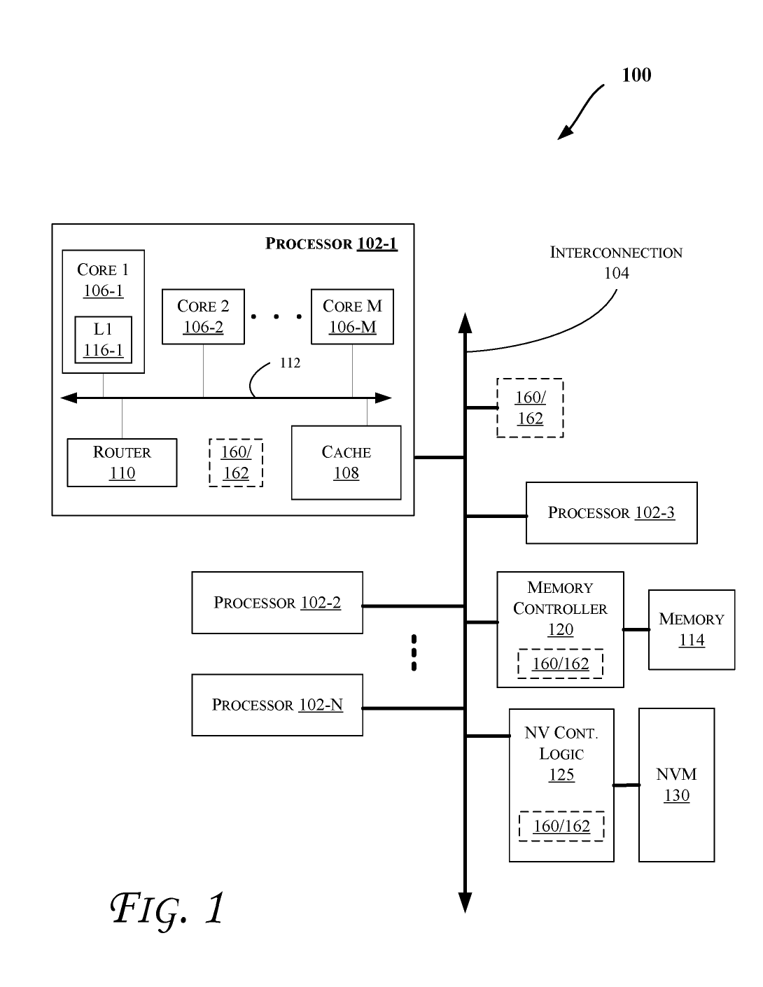

The techniques discussed herein may be provided in various computing systems (e.g., including a non-mobile computing device such as a desktop, workstation, server, rack system, etc. and a mobile computing device such as a smartphone, tablet, UMPC (Ultra-Mobile Personal Computer), laptop computer, Ultrabook™ computing device, smart watch, smart glasses, smart bracelet, etc.), including those discussed with reference to FIGS. 1-5. More particularly, FIG. 1 illustrates a block diagram of a computing system 100, according to an embodiment. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

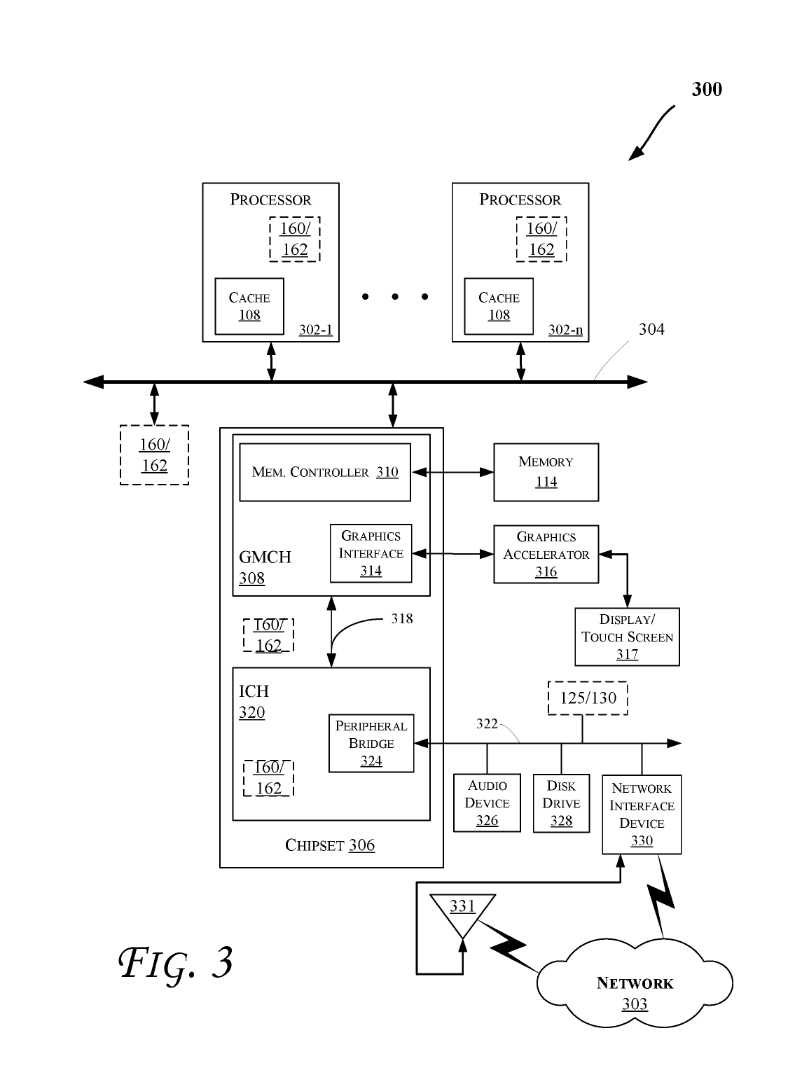

In an embodiment, the processor 102-1 may include one or more processor cores 106-1 through 106-M (referred to herein as “cores 106,” or more generally as “core 106”), a processor cache 108 (which may be a shared cache or a private cache in various embodiments), and/or a router 110. The processor cores 106 may be implemented on a single integrated circuit (IC) chip. Moreover, the chip may include one or more shared and/or private caches (such as processor cache 108), buses or interconnections (such as a bus or interconnection 112), logic 120, memory controllers (such as those discussed with reference to FIGS. 3-5), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The processor cache 108 may store data (e.g., including instructions) that are utilized by one or more components of the processor 102-1, such as the cores 106. For example, the processor cache 108 may locally cache data stored in a memory 114 for faster access by the components of the processor 102. As shown in FIG. 1, the memory 114 may be in communication with the processors 102 via the interconnection 104. In an embodiment, the processor cache 108 (that may be shared) may have various levels, for example, the processor cache 108 may be a mid-level cache and/or a last-level cache (LLC). Also, each of the cores 106 may include a level 1 (L1) processor cache (116-1) (generally referred to herein as “L1 processor cache 116”). Various components of the processor 102-1 may communicate with the processor cache 108 directly, through a bus (e.g., the bus 112), and/or a memory controller or hub.

As shown in FIG. 1, memory 114 may be coupled to other components of system 100 through a memory controller 120. Memory 114 includes volatile memory and may be interchangeably referred to as main memory. Even though the memory controller 120 is shown to be coupled between the interconnection 104 and the memory 114, the memory controller 120 may be located elsewhere in system 100. For example, memory controller 120 or portions of it may be provided within one of the processors 102 in some embodiments.

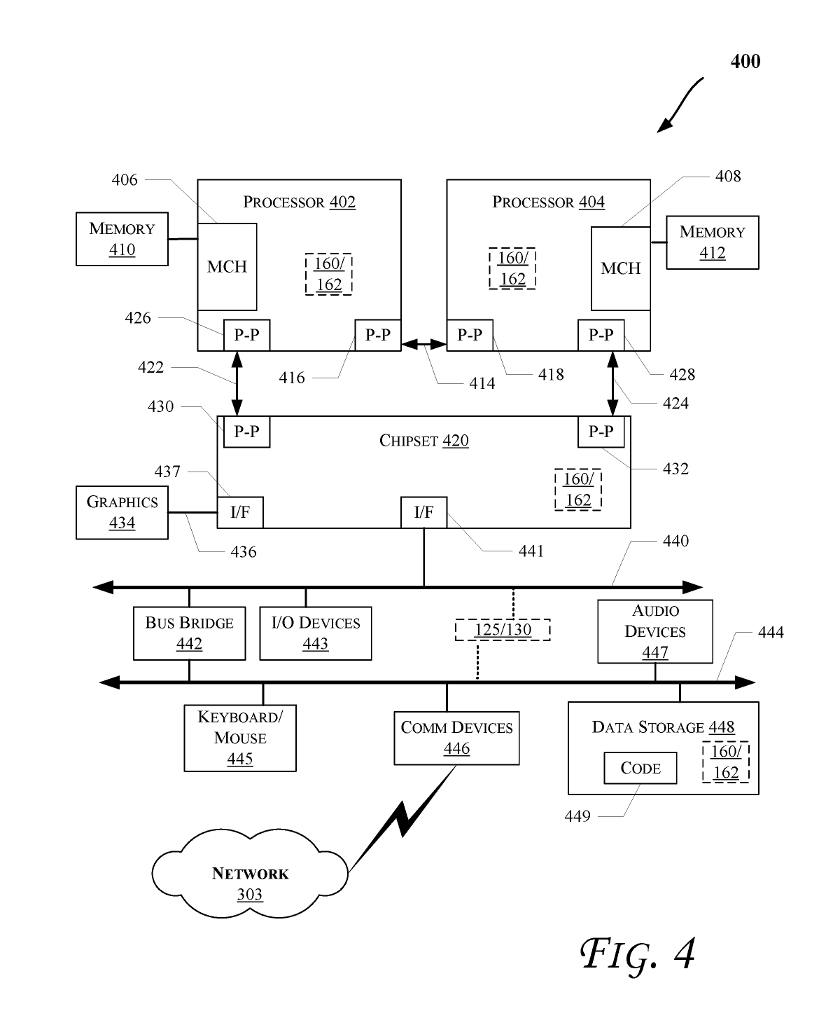

System 100 also includes NV memory 130 (or Non-Volatile Memory (NVM), e.g., compliant with NVMe (NVM express)) coupled to the interconnect 104 via NV controller logic 125. Hence, logic 125 may control access by various components of system 100 to the NVM 130. Furthermore, even though logic 125 is shown to be directly coupled to the interconnection 104 in FIG. 1, logic 125 may communicate via a storage bus/interconnect (such as the SATA (Serial Advanced Technology Attachment) bus, Peripheral Component Interconnect (PCI) (or PCI express (PCIe) interface), etc.) with one or more other components of system 100 (for example where the storage bus is coupled to interconnect 104 via some other logic like a bus bridge, chipset (such as discussed with reference to FIGS. 3, 4, and/or 5), etc.). Additionally, logic 125 may be incorporated into memory controller logic (such as those discussed with reference to FIGS. 3-5) or provided on a same Integrated Circuit (IC) device in various embodiments (e.g., on the same IC device as the NVM 130 or in the same enclosure as the NVM 130). System 100 may also include other types of non-volatile memory such as those discussed with reference to FIGS. 3-5, including for example a hard disk drive, etc.

FIG. 2A illustrates a block diagram of two-level system main memory, according to an embodiment. Some embodiments are directed towards system main memory 200 comprising two levels of memory (alternatively referred to herein as “2LM”) that include cached subsets of system disk level storage (in addition to, for example, run-time data). This main memory includes a first level memory 210 (alternatively referred to herein as “near memory”) comprising smaller and/or faster memory made of, for example, volatile memory 114 (e.g., including DRAM (Dynamic Random Access Memory)), NVM 130, etc.; and a second level memory 208 (alternatively referred to herein as “far memory”) which comprises larger and/or slower (with respect to the near memory) volatile memory (e.g., memory 114) or nonvolatile memory storage (e.g., NVM 130).

In an embodiment, the far memory is presented as “main memory” to the host Operating System (OS), while the near memory is a cache for the far memory that is transparent to the OS, thus rendering the embodiments described below to appear the same as general main memory solutions. The management of the two-level memory may be done by a combination of logic and modules executed via the host central processing unit (CPU) 102 (which is interchangeably referred to herein as “processor”). Near memory may be coupled to the host system CPU via one or more high bandwidth, low latency links, buses, or interconnects for efficient processing. Far memory may be coupled to the CPU via one or more low bandwidth, high latency links, buses, or interconnects (as compared to that of the near memory).

Referring to FIG. 2A, main memory 200 provides run-time data storage and access to the contents of system disk storage memory (such as disk drive 328 of FIG. 3 or data storage 448 of FIG. 4) to CPU 102. The CPU may include cache memory, which would store a subset of the contents of main memory 200. Far memory may comprise either volatile or nonvolatile memory as discussed herein. In such embodiments, near memory 210 serves a low-latency and high-bandwidth (i.e., for CPU 102 access) cache of far memory 208, which may have considerably lower bandwidth and higher latency (i.e., for CPU 102 access).

In an embodiment, near memory 210 is managed by Near Memory Controller (NMC) 204, while far memory 208 is managed by Far Memory Controller (FMC) 206. FMC 206 reports far memory 208 to the system operating system (OS) as main memory (i.e., the system OS recognizes the size of far memory 208 as the size of system main memory 200). The system OS and system applications are “unaware” of the existence of near memory 210 as it is a “transparent” cache of far memory 208.

CPU 102 further comprises 2LM engine module/logic 202. The “2LM engine” is a logical construct that may comprise hardware and/or micro-code extensions to support two-level main memory 200. For example, 2LM engine 202 may maintain a full tag table that tracks the status of all architecturally visible elements of far memory 208. For example, when CPU 102 attempts to access a specific data segment in main memory 200, 2LM engine 202 determines whether the data segment is included in near memory 210; if it is not, 2LM engine 202 fetches the data segment in far memory 208 and subsequently writes the data segment to near memory 210 (similar to a cache miss). It is to be understood that, because near memory 210 acts as a “cache” of far memory 208, 2LM engine 202 may further execute data perfecting or similar cache efficiency processes.

Further, 2LM engine 202 may manage other aspects of far memory 208. For example, in embodiments where far memory 208 comprises nonvolatile memory (e.g., NVM 130), it is understood that nonvolatile memory such as flash is subject to degradation of memory segments due to significant reads/writes. Thus, 2LM engine 202 may execute functions including wear-leveling, bad-block avoidance, and the like in a manner transparent to system software. For example, executing wear-leveling logic may include selecting segments from a free pool of clean unmapped segments in far memory 208 that have a relatively low erase cycle count.

In some embodiments, near memory 210 may be smaller in size than far memory 208, although the exact ratio may vary based on, for example, intended system use. In such embodiments, it is to be understood that because far memory 208 may comprise denser and/or cheaper nonvolatile memory, the size of the main memory 200 may be increased cheaply and efficiently and independent of the amount of DRAM (i.e., near memory 210) in the system.

In one embodiment, far memory 208 stores data in compressed form and near memory 210 includes the corresponding uncompressed version. Thus, when near memory 210 request content of far memory 208 (which could be a non-volatile DIMM in an embodiment), FMC 206 retrieves the content and returns it in fixed payload sizes tailored to match the compression algorithm in use (e.g., a 256B transfer).

As mentioned above, some approaches to write-back cache cleaning may involve an ALRU policy. It is aimed at cleaning the coldest (or least recently used) data first. In its basic form, the ALRU algorithm may select the least recently used cache lines and flush/remove them to backing storage (thus, allowing a high rate of cache hits). Unfortunately, this algorithm fails to take into account the performance limitations of hard drives. As least recently used lines may be randomly distributed on backing storage, cleaning each of them requires the hard drive to perform excessive seek operations. When working set is larger than cache device, cleaning of write-back cache becomes a key performance limiting factor (in worst cases causing cached volumes to be slower than ones that lack any caching mechanisms). By contrast, the aggressive cleaning policy discussed herein acknowledges fundamental limitations of hard drives and aims to instead overcome them with smart write-back cleaning, leading to vastly improved performance in such caches configurations.

FIG. 2B illustrates a flow diagram of a method 220 to provide an aggressive write-back cache cleaning policy for a NVM, according to an embodiment. In one embodiment, one or more of the operations of method 220 are performed by one or more components of the systems discussed with reference to FIG. 1, 2B, 3, 4, or 5 (including for example logic 160). In some embodiments, method 220 is performed for backing stores that include at least one Sequential Access Memory (SAM) storage device, such as an HDD (Hard Disk Drive, or more generally a hard disk), a hybrid drive (which includes both an HDD device and an SSD (Solid State Drive) or other type(s) of NVM discussed herein for caching), a magnetic tape, a recordable Compact Disk (CD), recordable Digital Versatile Disk (DVD), etc.

Referring to FIGS. 1-2B, at operation 221, it is determined whether the amount of dirty data in a cache 162 has reached/exceeded a threshold amount/value. Cache 162 may be provided in various components discussed herein, such as memory 114, NVM 130, or otherwise in locations such as those shown in FIGS. 1, 2A, and/or 3-5 (such as a cache coupled to interconnections 104/304/322/440/444, a cache inside logic 120 and/or logic 125, etc.). If the threshold value has not been reached at 221, operation 222 waits (or switches back to ALRU or LRU cleaning policy). If the threshold value is reached at 221, operation 224 determines whether the storage system is underutilized (e.g., the backing storage, HDD, NVM, etc. is idle). If the storage system is not underutilized at 224, operation 226 waits and/or returns to operation 221. Otherwise, at operation 228, one or more of the dirty cache lines are retrieved.

At operation 230, the retrieved dirty cache lines 228 are sorted in (e.g., ascending) order of backend storage LBAs. Operation 232 then optionally (e.g., for SAM type backing storage devices) groups the sorted cache lines by continuous LBA ranges. Operation 234 optionally (e.g., if operation 232 is performed) sorts the range size (e.g., in descending) order. Operation 236 then flushes/removes/cleans all or some of the dirty cache lines from the generated list (per operations 230 and/or 232-234). Method 220 then returns to operation 221.

FIG. 2C illustrates a sample graph of switching between aggressive and ALRU cache cleaning policies, according to an embodiment. More specifically, in one embodiment (such as discussed with reference to FIG. 2B), when the backing storage system is idle, the largest sequential (e.g., continuous LBA range on backing storage) set of dirty cache lines is detected and flushing is performed. As shown in FIG. 2C, it is possible to have configurable parameters for switching between aggressive and ALRU cache cleaning policies, for example: use the aggressive policy when dirty data is above X % (where X is an integer or real number) and return to ALRU/LRU policy when it is less then Y % (where Y is an integer or real number), e.g., assuming, Y<X). In this fashion, this processing-intensive algorithm is not utilized when the proportion of dirty cache lines is below some threshold value.

Furthermore, there is yet another advantage of the ability to keep dirty cache rate at consistently low levels. This advantage is data integrity. More particularly, it can be common for write-back cache deployments to use RAID-1 (Redundant Array of Inexpensive Drives level 1) style mirror of caching devices. However, when one replica in the mirror fails, it is a reasonable policy to immediately switch to write-through mode while cleaning all dirty data (so that a failure of second replica does not lead to data loss). The time between failure of first replica and cleaning of all dirty data is a vulnerability window in which failure of second replica means losing user data (and may then have to recover (potentially outdated or old) data from a backup source such as tapes). With less dirty data present, this switching operation may be shorter, whereas with conventional ALRU policy it is common for dirty data to reach close to 100% and never clean itself.

Moreover, one or more embodiments may be used to enhance both Windows® and Linux® in terms of: (1) performance in write-back mode from 2× up to 80× (with high spatial locality, when the working set is larger than caching device); and/or (2) improve data protection via reducing the vulnerability window after a single replica failure (when the mirrored pool of SSDs is used as cache). For example, one or more embodiments may be applied to B-Cache™, FlashCache™, and/or DM-Cache™ in a Linux kernel.

FIG. 3 illustrates a block diagram of a computing system 300 in accordance with an embodiment. The computing system 300 may include one or more central processing unit(s) (CPUs) 302 or processors that communicate via an interconnection network (or bus) 304. The processors 302 may include a general purpose processor, a network processor (that processes data communicated over a computer network 303), an application processor (such as those used in cell phones, smart phones, etc.), or other types of a processor (including a reduced instruction set computer (RISC) processor or a complex instruction set computer (CISC)).

Various types of computer networks 303 may be utilized including wired (e.g., Ethernet, Gigabit, Fiber, etc.) or wireless networks (such as cellular, including 3G (Third-Generation Cell-Phone Technology or 3rd Generation Wireless Format (UWCC)), 4G (Fourth-Generation Cell-Phone Technology), 4G Advanced, Low Power Embedded (LPE), Long Term Evolution (LTE), LTE advanced, etc.). Moreover, the processors 302 may have a single or multiple core design. The processors 302 with a multiple core design may integrate different types of processor cores on the same integrated circuit (IC) die. Also, the processors 302 with a multiple core design may be implemented as symmetrical or asymmetrical multiprocessors.

In an embodiment, one or more of the processors 302 may be the same or similar to the processors 102 of FIG. 1. For example, one or more of the processors 302 may include one or more of the cores 106 and/or processor cache 108. Also, the operations discussed with reference to FIGS. 1-2D may be performed by one or more components of the system 300.

A chipset 306 may also communicate with the interconnection network 304. The chipset 306 may include a graphics and memory control hub (GMCH) 308. The GMCH 308 may include a memory controller 310 (which may be the same or similar to the memory controller 120 of FIG. 1 in an embodiment) that communicates with the memory 114. The memory 114 may store data, including sequences of instructions that are executed by the CPU 302, or any other device included in the computing system 300. Also, system 300 includes logic 125/160 and/or NVM 130/162 in various locations such as shown or not shown. In one embodiment, the memory 114 may include one or more volatile memory devices such as random access memory (RAM), dynamic RAM (DRAM), synchronous DRAM (SDRAM), static RAM (SRAM), or other types of memory devices. Nonvolatile memory may also be utilized such as a hard disk drive, flash, etc., including any NVM discussed herein. Additional devices may communicate via the interconnection network 304, such as multiple CPUs and/or multiple system memories.

The GMCH 308 may also include a graphics interface 314 that communicates with a graphics accelerator 316. In one embodiment, the graphics interface 314 may communicate with the graphics accelerator 316 via an accelerated graphics port (AGP) or Peripheral Component Interconnect (PCI) (or PCI express (PCIe) interface). In an embodiment, a display 317 (such as a flat panel display, touch screen, etc.) may communicate with the graphics interface 314 through, for example, a signal converter that translates a digital representation of an image stored in a memory device such as video memory or system memory into display signals that are interpreted and displayed by the display. The display signals produced by the display device may pass through various control devices before being interpreted by and subsequently displayed on the display 317.

A hub interface 318 may allow the GMCH 308 and an input/output control hub (ICH) 320 to communicate. The ICH 320 may provide an interface to I/O devices that communicate with the computing system 300. The ICH 320 may communicate with a bus 322 through a peripheral bridge (or controller) 324, such as a peripheral component interconnect (PCI) bridge, a universal serial bus (USB) controller, or other types of peripheral bridges or controllers. The bridge 324 may provide a data path between the CPU 302 and peripheral devices. Other types of topologies may be utilized. Also, multiple buses may communicate with the ICH 320, e.g., through multiple bridges or controllers. Moreover, other peripherals in communication with the ICH 320 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 322 may communicate with an audio device 326, one or more disk drive(s) 328, and a network interface device 330 (which is in communication with the computer network 303, e.g., via a wired or wireless interface). As shown, the network interface device 330 may be coupled to an antenna 331 to wirelessly (e.g., via an Institute of Electrical and Electronics Engineers (IEEE) 802.11 interface (including IEEE 802.11a/b/g/n/ac, etc.), cellular interface, 3G, 4G, LPE, etc.) communicate with the network 303. Other devices may communicate via the bus 322. Also, various components (such as the network interface device 330) may communicate with the GMCH 308 in some embodiments. In addition, the processor 302 and the GMCH 308 may be combined to form a single chip. Furthermore, the graphics accelerator 316 may be included within the GMCH 308 in other embodiments.

Furthermore, the computing system 300 may include volatile and/or nonvolatile memory. For example, nonvolatile memory may include one or more of the following: read-only memory (ROM), programmable ROM (PROM), erasable PROM (EPROM), electrically EPROM (EEPROM), a disk drive (e.g., 328), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 4 illustrates a computing system 400 that is arranged in a point-to-point (PtP) configuration, according to an embodiment. In particular, FIG. 4 shows a system where processors, memory, and input/output devices are interconnected by a number of point-to-point interfaces. The operations discussed with reference to FIGS. 1-3 may be performed by one or more components of the system 400.

As illustrated in FIG. 4, the system 400 may include several processors, of which only two, processors 402 and 404 are shown for clarity. The processors 402 and 404 may each include a local memory controller hub (MCH) 406 and 408 to enable communication with memories 410 and 412. The memories 410 and/or 412 may store various data such as those discussed with reference to the memory 114 of FIGS. 1 and/or 3. Also, MCH 406 and 408 may include the memory controller 120 in some embodiments. Furthermore, system 400 includes logic 125/160 and/or NVM 130/162 in various locations such as shown or not shown. The logic 125/160 and/or NVM 130/162 may be coupled to system 400 via bus 440 or 444, via other point-to-point connections to the processor(s) 402 or 404 or chipset 420, etc. in various embodiments.

In an embodiment, the processors 402 and 404 may be one of the processors 302 discussed with reference to FIG. 3. The processors 402 and 404 may exchange data via a point-to-point (PtP) interface 414 using PtP interface circuits 416 and 418, respectively. Also, the processors 402 and 404 may each exchange data with a chipset 420 via individual PtP interfaces 422 and 424 using point-to-point interface circuits 426, 428, 430, and 432. The chipset 420 may further exchange data with a high-performance graphics circuit 434 via a high-performance graphics interface 436, e.g., using a PtP interface circuit 437. As discussed with reference to FIG. 3, the graphics interface 436 may be coupled to a display device (e.g., display 317) in some embodiments.

In one embodiment, one or more of the cores 106 and/or processor cache 108 of FIG. 1 may be located within the processors 402 and 404 (not shown). Other embodiments, however, may exist in other circuits, logic units, or devices within the system 400 of FIG. 4. Furthermore, other embodiments may be distributed throughout several circuits, logic units, or devices illustrated in FIG. 4.

The chipset 420 may communicate with a bus 440 using a PtP interface circuit 441. The bus 440 may have one or more devices that communicate with it, such as a bus bridge 442 and I/O devices 443. Via a bus 444, the bus bridge 442 may communicate with other devices such as a keyboard/mouse 445, communication devices 446 (such as modems, network interface devices, or other communication devices that may communicate with the computer network 303, as discussed with reference to network interface device 330 for example, including via antenna 331), audio I/O device, and/or a data storage device 448. The data storage device 448 may store code 449 that may be executed by the processors 402 and/or 404.

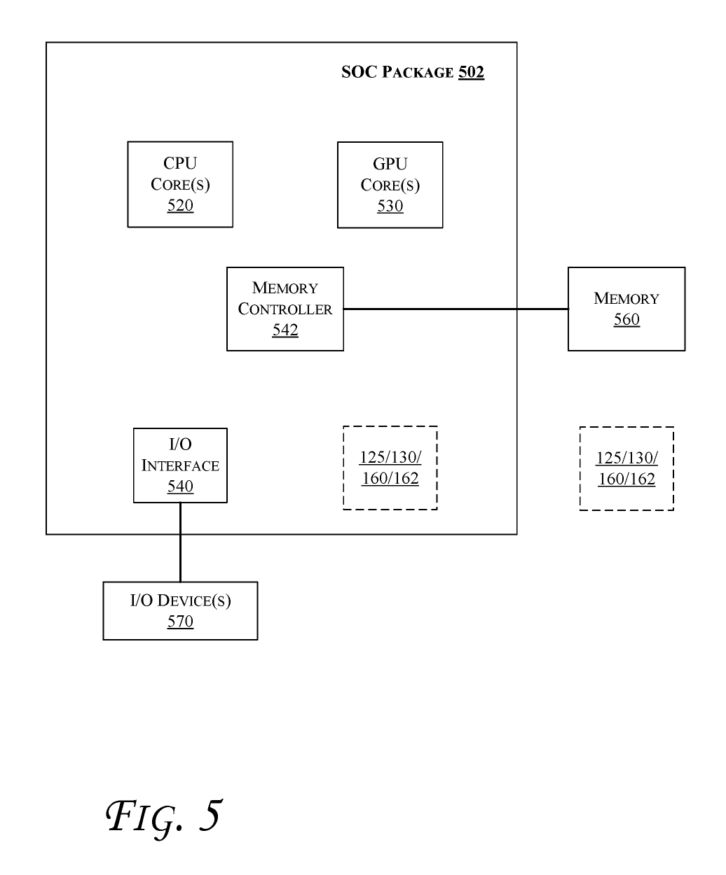

In some embodiments, one or more of the components discussed herein can be embodied as a System On Chip (SOC) device. FIG. 5 illustrates a block diagram of an SOC package in accordance with an embodiment. As illustrated in FIG. 5, SOC 502 includes one or more Central Processing Unit (CPU) cores 520, one or more Graphics Processor Unit (GPU) cores 530, an Input/Output (I/O) interface 540, and a memory controller 542. Various components of the SOC package 502 may be coupled to an interconnect or bus such as discussed herein with reference to the other figures. Also, the SOC package 502 may include more or less components, such as those discussed herein with reference to the other figures. Further, each component of the SOC package 520 may include one or more other components, e.g., as discussed with reference to the other figures herein. In one embodiment, SOC package 502 (and its components) is provided on one or more Integrated Circuit (IC) die, e.g., which are packaged onto a single semiconductor device.

As illustrated in FIG. 5, SOC package 502 is coupled to a memory 560 (which may be similar to or the same as memory discussed herein with reference to the other figures) via the memory controller 542. In an embodiment, the memory 560 (or a portion of it) can be integrated on the SOC package 502.

The I/O interface 540 may be coupled to one or more I/O devices 570, e.g., via an interconnect and/or bus such as discussed herein with reference to other figures. I/O device(s) 570 may include one or more of a keyboard, a mouse, a touchpad, a display, an image/video capture device (such as a camera or camcorder/video recorder), a touch screen, a speaker, or the like. Furthermore, SOC package 502 may include/integrate items 125, 130, 160, and/or 162 in an embodiment. Alternatively, items 125, 130, 160, and/or 162 may be provided outside of the SOC package 502 (i.e., as a discrete logic).

Embodiments described herein can be powered by a battery, wireless charging, a renewal energy source (e.g., solar power or motion-based charging), or when connected to a charging port or wall outlet.

The following examples pertain to further embodiments. Example 1 includes an apparatus comprising: logic to cause removal of one or more cache lines from a cache based at least in part on a list of cache lines in the cache, wherein the cache is to store data to be stored in a backing storage system, wherein the list of cache lines is to comprise a sorted list of Logic Block Addresses (LBAs) on the backing storage system that correspond to the one or more cache lines. Example 2 includes the apparatus of example 1, comprising logic to group the one or more cache lines into one or more LBA ranges. Example 3 includes the apparatus of example 2, comprising logic to sort the one or more LBA ranges by a size of the one or more LBA ranges. Example 4 includes the apparatus of example 1, wherein the logic is to cause removal of the one or more cache lines in response to an indication that the one or more cache lines are to be modified or replaced and in response to comparison of a number of the one or more cache lines and a threshold value. Example 5 includes the apparatus of example 1, comprising logic to determine whether to cause removal of the one or more cache lines based at least in part on: the list of the cache lines or an Approximately Least Recently Used (ALRU) cleaning policy. Example 6 includes the apparatus of example 1, wherein the one or more cache lines are to be written to the cache in accordance with a write-back policy. Example 7 includes the apparatus of example 1, wherein the cache is to comprise at least one Solid State Drive (SSD). Example 8 includes the apparatus of example 1, wherein the backing storage system is to comprise at least one Synchronous Access Memory (SAM) device. Example 9 includes the apparatus of example 1, wherein the one or more cache lines are to store data before that data is to be written to the backing storage system. Example 10 includes the apparatus of example 1, wherein the backing storage system is to comprise a plurality of storage nodes. Example 11 includes the apparatus of example 10, wherein the plurality of storage nodes is to comprise a near storage node and/or a far storage node. Example 12 includes the apparatus of example 10, wherein the plurality of storage nodes is to communicate via a network. Example 13 includes the apparatus of example 12, wherein the network is to comprise a wired and/or a wireless network. Example 14 includes the apparatus of example 10, wherein each of the plurality of storage nodes is to comprise one or more of: a hard disk drive, a solid state drive, and a hybrid drive. Example 15 includes the apparatus of example 1, wherein the cache or the backing storage system are to comprise Non-Volatile Memory (NVM), wherein the non-volatile memory is to comprise one or more of: nanowire memory, Ferro-electric Transistor Random Access Memory (FeTRAM), Magnetoresistive Random Access Memory (MRAM), flash memory, Spin Torque Transfer Random Access Memory (STTRAM), Resistive Random Access Memory, byte addressable 3-Dimensional Cross Point Memory, PCM (Phase Change Memory), write-in-place non-volatile memory, and volatile memory backed by a power reserve to retain data during power failure or power disruption. Example 16 includes the apparatus of example 1, further comprising one or more of: at least one processor, having one or more processor cores, communicatively coupled to the cache or the backing storage system, a battery communicatively coupled to the apparatus, or a network interface communicatively coupled to the apparatus.

Example 17 includes a method comprising: causing removal of one or more cache lines from a cache based at least in part on a list of cache lines in the cache, wherein the cache stores data to be stored in a backing storage system, wherein the list of cache lines comprises a sorted list of Logic Block Addresses (LBAs) on the backing storage system that correspond to the one or more cache lines. Example 18 includes the method of example 17, further comprising grouping the one or more cache lines into one or more LBA ranges. Example 19 includes the method of example 18, further comprising sorting the one or more LBA ranges by a size of the one or more LBA ranges. Example 20 includes the method of example 17, wherein causing removal of the one or more cache lines is to be performed in response to an indication that the one or more cache lines are to be modified or replaced. Example 21 includes the method of example 17, further comprising writing the one or more cache lines to the cache in accordance with a write-back policy.

Example 22 includes one or more computer-readable medium comprising one or more instructions that when executed on at least one processor configure the at least one processor to perform one or more operations to: cause removal of one or more cache lines from a cache based at least in part on a list of cache lines in the cache, wherein the cache stores data to be stored in a backing storage system, wherein the list of cache lines comprises a sorted list of Logic Block Addresses (LBAs) on the backing storage system that correspond to the one or more cache lines. Example 23 includes the one or more computer-readable medium of example 22, further comprising one or more instructions that when executed on the processor configure the processor to perform one or more operations to group the one or more cache lines into one or more LBA ranges. Example 24 includes the one or more computer-readable medium of example 23, further comprising one or more instructions that when executed on the processor configure the processor to perform one or more operations to sort the one or more LBA ranges by a size of the one or more LBA ranges. Example 25 includes the one or more computer-readable medium of example 22, further comprising one or more instructions that when executed on the processor configure the processor to perform one or more operations to write the one or more cache lines to the cache in accordance with a write-back policy.

Example 26 includes a computing system comprising: a processor; memory, coupled to the processor, to store data corresponding to object stores; and logic to cause removal of one or more cache lines from a cache based at least in part on a list of cache lines in the cache, wherein the cache is to store data to be stored in a backing storage system, wherein the list of cache lines is to comprise a sorted list of Logic Block Addresses (LBAs) on the backing storage system that correspond to the one or more cache lines. Example 27 includes the computing system of example 26, comprising logic to group the one or more cache lines into one or more LBA ranges. Example 28 includes the computing system of example 26, wherein the logic is to cause removal of the one or more cache lines in response to an indication that the one or more cache lines are to be modified or replaced and in response to comparison of a number of the one or more cache lines and a threshold value. Example 29 includes the computing system of example 26, comprising logic to determine whether to cause removal of the one or more cache lines based at least in part on: the list of the cache lines or an Approximately Least Recently Used (ALRU) cleaning policy. Example 30 includes the computing system of example 26, wherein the one or more cache lines are to be written to the cache in accordance with a write-back policy. Example 31 includes the computing system of example 26, wherein the cache is to comprise at least one Solid State Drive (SSD). Example 32 includes the computing system of example 26, wherein the backing storage system is to comprise at least one Synchronous Access Memory (SAM) device. Example 33 includes the computing system of example 26, wherein the one or more cache lines are to store data before that data is to be written to the backing storage system. Example 34 includes the computing system of example 26, wherein the backing storage system is to comprise a plurality of storage nodes. Example 35 includes the computing system of example 26, wherein the cache or the backing storage system are to comprise Non-Volatile Memory (NVM), wherein the non-volatile memory is to comprise one or more of: nanowire memory, Ferro-electric Transistor Random Access Memory (FeTRAM), Magnetoresistive Random Access Memory (MRAM), flash memory, Spin Torque Transfer Random Access Memory (STTRAM), Resistive Random Access Memory, byte addressable 3-Dimensional Cross Point Memory, PCM (Phase Change Memory), write-in-place non-volatile memory, and volatile memory backed by a power reserve to retain data during power failure or power disruption. Example 36 includes the computing system of example 26, further comprising one or more of: the processor, having one or more processor cores, communicatively coupled to the cache or the backing storage system, a battery communicatively coupled to the apparatus, or a network interface communicatively coupled to the apparatus.

Example 37 includes an apparatus comprising means to perform a method as set forth in any preceding example. Example 38 comprises machine-readable storage including machine-readable instructions, when executed, to implement a method or realize an apparatus as set forth in any preceding example.

In various embodiments, the operations discussed herein, e.g., with reference to FIGS. 1-5, may be implemented as hardware (e.g., circuitry), software, firmware, microcode, or combinations thereof, which may be provided as a computer program product, e.g., including a tangible (e.g., non-transitory) machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a memory device such as those discussed with respect to FIGS. 1-5.

Additionally, such tangible computer-readable media may be downloaded as a computer program product, wherein the program may be transferred from a remote computer (e.g., a server) to a requesting computer (e.g., a client) by way of data signals (such as in a carrier wave or other propagation medium) via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features, numerical values, and/or methodological acts, it is to be understood that claimed subject matter may not be limited to the specific features, numerical values, or acts described. Rather, the specific features, numerical values, and acts are disclosed as sample forms of implementing the claimed subject matter.

1. An apparatus comprising:
logic to cause removal of one or more cache lines from a cache based at least in part on a list of cache lines in the cache,
wherein the cache is to store data to be stored in a backing storage system, wherein the list of cache lines is to comprise a sorted list of Logic Block Addresses (LBAs) on the backing storage system that correspond to the one or more cache lines.

2. The apparatus of claim 1, comprising logic to group the one or more cache lines into one or more LBA ranges.

3. The apparatus of claim 2, comprising logic to sort the one or more LBA ranges by a size of the one or more LBA ranges.

4. The apparatus of claim 1, wherein the logic is to cause removal of the one or more cache lines in response to an indication that the one or more cache lines are to be modified or replaced and in response to comparison of a number of the one or more cache lines and a threshold value.

5. The apparatus of claim 1, comprising logic to determine whether to cause removal of the one or more cache lines based at least in part on: the list of the cache lines or an Approximately Least Recently Used (ALRU) cleaning policy.

6. The apparatus of claim 1, wherein the one or more cache lines are to be written to the cache in accordance with a write-back policy.

7. The apparatus of claim 1, wherein the cache is to comprise at least one Solid State Drive (SSD).

8. The apparatus of claim 1, wherein the backing storage system is to comprise at least one Synchronous Access Memory (SAM) device.

9. The apparatus of claim 1, wherein the one or more cache lines are to store data before that data is to be written to the backing storage system.

10. The apparatus of claim 1, wherein the backing storage system is to comprise a plurality of storage nodes.

11. The apparatus of claim 10, wherein the plurality of storage nodes is to comprise a near storage node and/or a far storage node.

12. The apparatus of claim 10, wherein the plurality of storage nodes is to communicate via a network.

13. The apparatus of claim 12, wherein the network is to comprise a wired and/or a wireless network.

14. The apparatus of claim 10, wherein each of the plurality of storage nodes is to comprise one or more of: a hard disk drive, a solid state drive, and a hybrid drive.

15. The apparatus of claim 1, wherein the cache or the backing storage system are to comprise Non-Volatile Memory (NVM), wherein the non-volatile memory is to comprise one or more of: nanowire memory, Ferro-electric Transistor Random Access Memory (FeTRAM), Magnetoresistive Random Access Memory (MRAM), flash memory, Spin Torque Transfer Random Access Memory (STTRAM), Resistive Random Access Memory, byte addressable 3-Dimensional Cross Point Memory, PCM (Phase Change Memory), write-in-place non-volatile memory, and volatile memory backed by a power reserve to retain data during power failure or power disruption.

16. The apparatus of claim 1, further comprising one or more of: at least one processor, having one or more processor cores, communicatively coupled to the cache or the backing storage system, a battery communicatively coupled to the apparatus, or a network interface communicatively coupled to the apparatus.

17. A method comprising:
causing removal of one or more cache lines from a cache based at least in part on a list of cache lines in the cache,
wherein the cache stores data to be stored in a backing storage system, wherein the list of cache lines comprises a sorted list of Logic Block Addresses (LBAs) on the backing storage system that correspond to the one or more cache lines.

18. The method of claim 17, further comprising grouping the one or more cache lines into one or more LBA ranges.

19. The method of claim 18, further comprising sorting the one or more LBA ranges by a size of the one or more LBA ranges.

20. The method of claim 17, wherein causing removal of the one or more cache lines is to be performed in response to an indication that the one or more cache lines are to be modified or replaced.

21. The method of claim 17, further comprising writing the one or more cache lines to the cache in accordance with a write-back policy.

22. One or more computer-readable medium comprising one or more instructions that when executed on at least one processor configure the at least one processor to perform one or more operations to:
cause removal of one or more cache lines from a cache based at least in part on a list of cache lines in the cache,
wherein the cache stores data to be stored in a backing storage system, wherein the list of cache lines comprises a sorted list of Logic Block Addresses (LBAs) on the backing storage system that correspond to the one or more cache lines.

23. The one or more computer-readable medium of claim 22, further comprising one or more instructions that when executed on the processor configure the processor to perform one or more operations to group the one or more cache lines into one or more LBA ranges.

24. The one or more computer-readable medium of claim 23, further comprising one or more instructions that when executed on the processor configure the processor to perform one or more operations to sort the one or more LBA ranges by a size of the one or more LBA ranges.

25. The one or more computer-readable medium of claim 22, further comprising one or more instructions that when executed on the processor configure the processor to perform one or more operations to write the one or more cache lines to the cache in accordance with a write-back policy.
